(19) United States
(12) Patent Application Publication
(10) Pub. No.: US 2015/0272398 A1
(43) Pub. Date: Oct. 1, 2015

(54) FOAM DISPENSER WITH AN INTEGRAL PISTON VALVE

(71) Applicant: Arminak & Associates, LLC, Azusa, CA (US)

(72) Inventor: Armin Arminak, Pasadena, CA (US)

(21) Appl. No.: 14/741,690

(22) Filed: Jun. 17, 2015

Related U.S. Application Data
(63) Continuation of application No. PCT/US2013/070977, filed on Nov. 20, 2013.
(60) Provisional application No. 61/740,007, filed on Dec. 20, 2012.
(60) Provisional application No. 61/903,462, filed on Nov. 13, 2013.

(51) Int. Cl. A47K 5/16; B05B 11/00; B05B 7/24

(52) U.S. Cl. CPC A47K 5/16; B05B 7/2491; B05B 11/3001; B05B 11/3066

(57) ABSTRACT

A foam-dispensing pump includes an actuator, a collar, a housing, an air piston, a liquid piston, a mesh element and an air valve structure. The collar is constructed and arranged for attachment to a liquid storage container and a portion of the actuator is received by the collar. The air piston is constructed and arranged to be moveable within the housing. The liquid piston is constructed and arranged to be moveable within the housing. The mesh element is constructed and arranged to receive air and liquid for the production of foam. The air valve structure includes an annular valve lip which is formed as part of the liquid piston and a cooperating annular valve element which is received by the air piston.

### CROSS REFERENCE TO RELATED APPLICATIONS

This application is a continuation of PCT/US2013/070977 filed Nov. 20, 2013 which claims the benefit of U.S. Provisional Patent Application Ser. No. 61/740,007 filed Dec. 20, 2012 and U.S. Provisional Patent Application Ser. No. 61/903,462 filed Nov. 13, 2013, all of which are hereby incorporated by reference.

### BACKGROUND

Foam-dispensing pumps are constructed and arranged for enabling the mixture of air and a selected liquid, in a desired ratio, for the production of foam. This mixture of air and a selected liquid is pushed through a screen or mesh layer of some suitable material and construction in order for aeration of this mixture to occur. The charge of air is divided into smaller bubbles which are coated with a thin film of the selected liquid. The opening size of the screen (or mesh) and the number of passes through other (optional) downstream screens, typically with smaller openings, influences the “quality” of the foam which is ultimately dispensed to the user. The mixture ratio of the charge of air and the charge of liquid also influences the “quality” of the foam relative to whether the foam is considered too wet and thus runny or too dry and unacceptable.

While the selection of a proper mixture ratio of air and liquid is important, it is also important to have a pump mechanism which is cost-effective to manufacture and is reliable. The concept of “reliable” is embodied, at least in part, in the accuracy of the metering of air and the delivery of liquid for the mixture. “Reliable” is also embodied in the valve structures which perform their metering and delivery responsibilities as intended, and without any noticeable leakage or malfunction.

The air valve structures which are included as part of this disclosed foam-dispensing pump provides reliable valve structures for use in this type of pump.

### SUMMARY

Air valve structures are disclosed which are constructed and arranged for use as part of a foam-dispensing pump. The pump includes an air cylinder for use in delivering a charge of air to a mixing chamber which is upstream from a mesh insert. The air cylinder includes a housing and a reciprocating air piston and the combination defines an interior air chamber. The pump also includes a liquid cylinder for use in delivering a charge of liquid to the mixing chamber. The liquid cylinder includes a portion of the housing and a reciprocating liquid piston.

In one embodiment, as disclosed herein, the pump is assembled to a container which includes a volume of the selected liquid. The representative container has an externally-threaded neck and the pump includes an internally-threaded collar which securely attaches the pump to the container. Other container constructions and other means of connection or attachment are contemplated. In this assembled and attached condition one portion of the pump extends in an axially downward direction into the interior of the container. Another portion of the pump extends in an axially upward direction and protrudes beyond the upper surface of the collar. This “another portion” includes an actuator which defines a dispensing passage and outlet opening for the foam which is produced as the air and liquid mixture passes through and exits from the mesh insert.

The actuator is constructed and arranged to reciprocate axially through an upper opening in the collar. The downward travel of the actuator is the result of manual depression (i.e. a manual downward force on the upper surface of the actuator). The upward travel of the actuator is the result of a spring and a spring-biasing arrangement within the pump. As the actuator is manually pushed in an axially downward direction, an air piston and a liquid piston are each driven axially as the initiating steps in the delivery of air and liquid, respectively. With each stroke of the actuator a charge of air and a charge of liquid are delivered into a mixing area or chamber which is upstream from the mesh insert used for aeration. The flow of air is dependent on the opening of the disclosed air valve so that a portion of the air which is within the air chamber is able to escape as the air chamber volume is reduced by the downward travel of the air piston, as driven by the actuator. When the pressure level within the air chamber is below the resiliency force of the air valve in order to remain open, the mixing air side of the air valve closes. Several air valve structures are disclosed representative of the design embodiments which are contemplated.

As the spring arrangement acts on the air piston and thereby pushes upwardly on the actuator, the pump components return to what is best described as their “starting position”, ready for another manual actuation (i.e. stroke) and for the delivery of another charge or dose of foam. This upward travel of the air piston creates a vacuum within the air chamber and this negative pressure needs to be relieved by the introduction of make-up air. The disclosed air valves are constructed and arranged to allow the introduction of make-up air into the air chamber. Once the negative pressure within the air chamber returns to a pressure which is near atmospheric pressure, the make-up air side of the air valve closes.

In order to provide these described air valve functions, the disclosed foam-dispensing pump includes several embodiments of an air valve structure which includes an annular valve lip and an annular valve element. The annular valve lip of each embodiment is formed as an integral portion of the liquid piston. This valve lip cooperates with the valve element to control the delivery (and amount) of air for mixing with the liquid. The disclosed valve structures achieve a reliable seal which prevents the migration of foam or liquid into the air chamber.

Each disclosed air valve structure provides an improved construction which is easy to fabricate and easy to install and which is reliable and accurate in terms of air-flow management. The concept of air-flow management includes both timing and volume.

### BRIEF DESCRIPTION OF THE DRAWINGS

FIG. 1 is a perspective view of a foam-dispensing pump according to the present disclosure.

FIG. 2 is a side elevational view, in full section, of the FIG. 1 foam-dispensing pump.

FIG. 3 is a partial, enlarged section view of the FIG. 2 illustration.

FIG. 4 is a bottom perspective view of an actuator which comprises one component part of the FIG. 1 foam-dispensing pump.

FIG. 5 is a side elevational view, in full section, of the FIG. 4 actuator.

FIG. 6 is a bottom perspective view of a collar which comprises one component part of the FIG. 1 foam-dispensing pump.

FIG. 7 is a side elevational view, in full section, of the FIG. 6 collar.

FIG. 8 is a top perspective view of an air piston which comprises one component part of the FIG. 1 foam-dispensing pump.

FIG. 9 is a side elevational view, in full section, of the FIG. 8 air piston.

FIG. 10 is a top perspective view of a liquid piston which comprises one component part of the FIG. 1 foam-dispensing pump.

FIG. 11A is a side elevational view, in full section, of the FIG. 10 liquid piston.

FIG. 11B is an enlarged, partial, side elevational view, in full section, of the FIG. 10 liquid piston with an alternative form of valve lip.

FIG. 11C is an enlarged, partial, side elevational view, in full section, of the FIG. 10 liquid piston with an alternative form of valve lip.

FIG. 12 is a bottom perspective view of a housing which comprises one component part of the FIG. 1 foam-dispensing pump.

FIG. 13 is a side elevational view, in full section, of the FIG. 12 housing.

FIG. 14 is a side elevational view, in full section, of a mesh insert which comprises one component part of the FIG. 1 foam-dispensing pump.

FIG. 15 is a top perspective view of a spring stem which comprises one component part of the FIG. 1 foam-dispensing pump.

FIG. 16 is a bottom perspective view of the FIG. 15 spring stem.

FIG. 17 is a side elevational view, in full section, of the FIG. 15 spring stem.

FIG. 18 is a top perspective view of a pull stick which comprises one component part of the FIG. 1 foam-dispensing pump.

FIG. 19 is a side elevational view, in full section, of the FIG. 18 pull stick.

FIG. 20 is a side elevational view, in full section, of an air valve structure which comprises one portion of the FIG. 1 foam-dispensing pump.

FIG. 21 is a top perspective view of an annular valve element which comprises one component part of the FIG. 20 air valve structure.

FIG. 22 is a side elevational view, in full section, of the FIG. 21 annular valve element.

### DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

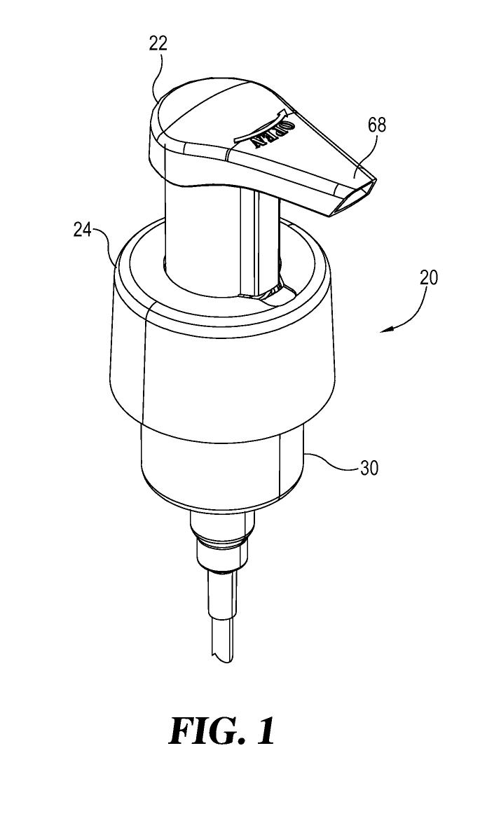

Referring to FIGS. 1, 2 and 3, a foam-dispensing pump 20 according to the present disclosure is illustrated. Pump 20 includes an actuator 22, a collar 24, an air piston 26, a liquid piston 28, a housing 30, a mesh insert 32, a spring 34, a spring stem 36 and a pull stick 38. These components cooperate for the delivery of an amount or dose of foam in response to a depression stroke (axially downward movement) of the actuator. Pump 20 further includes an air valve structure 40 (see FIG. 20) which includes an annular sleeve component 42 and a cooperating annular valve element 44.

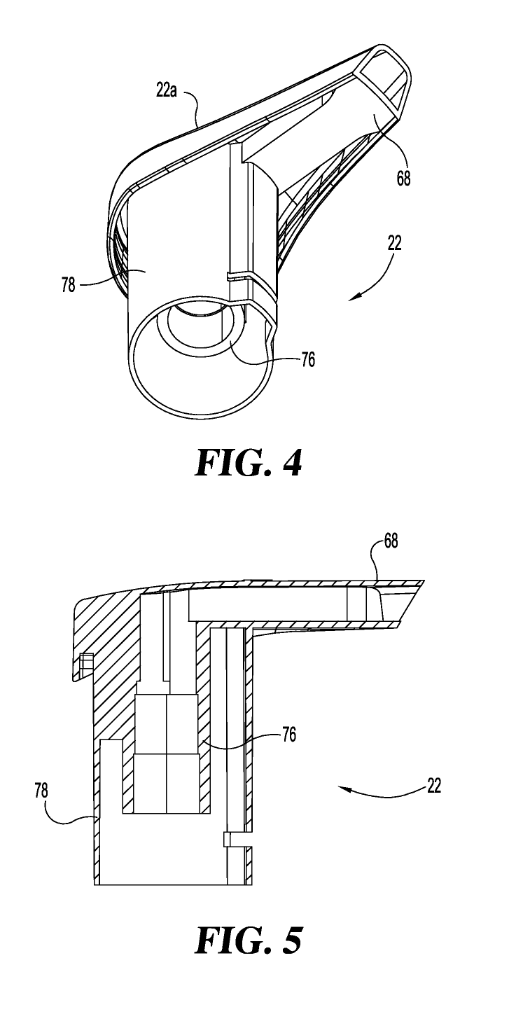

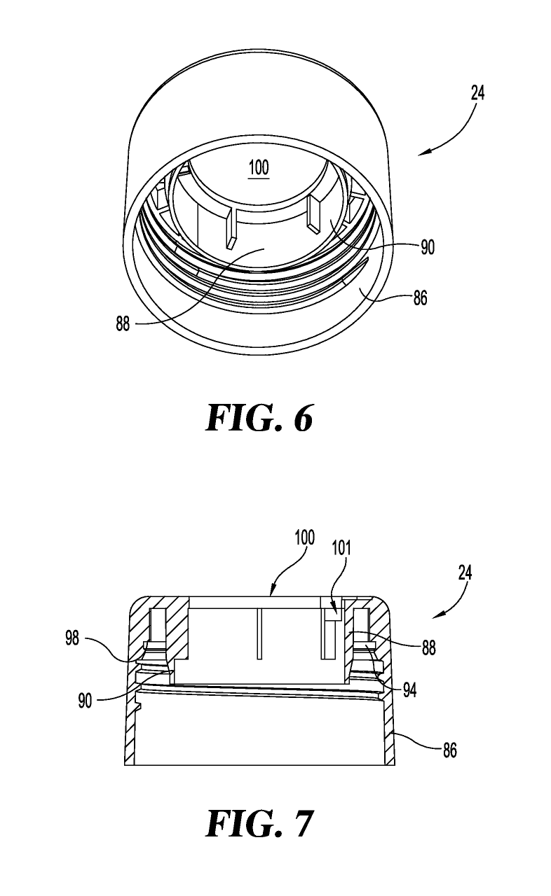

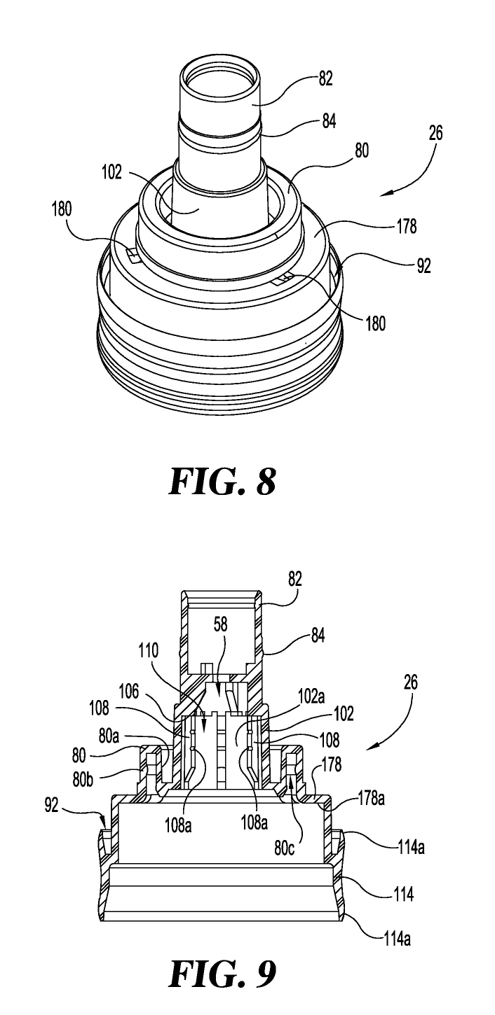

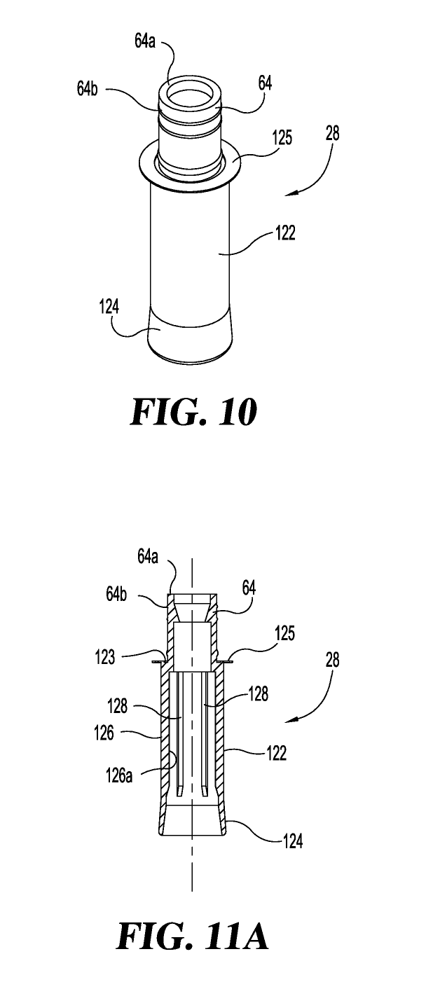

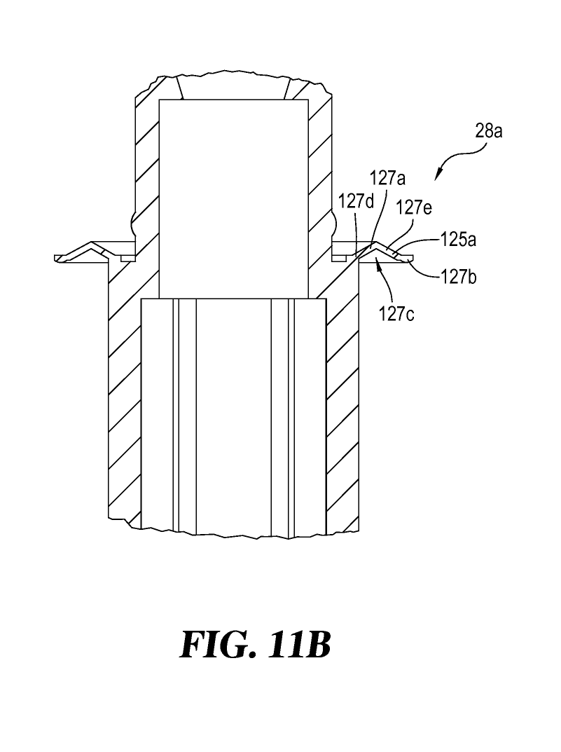

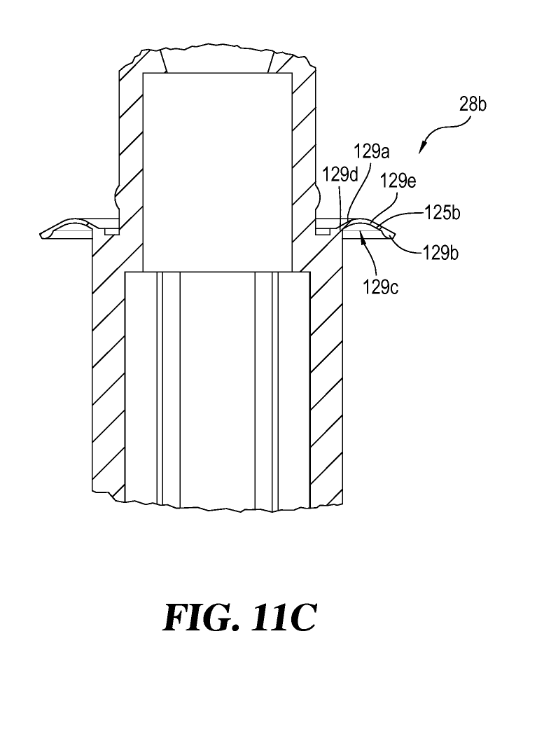

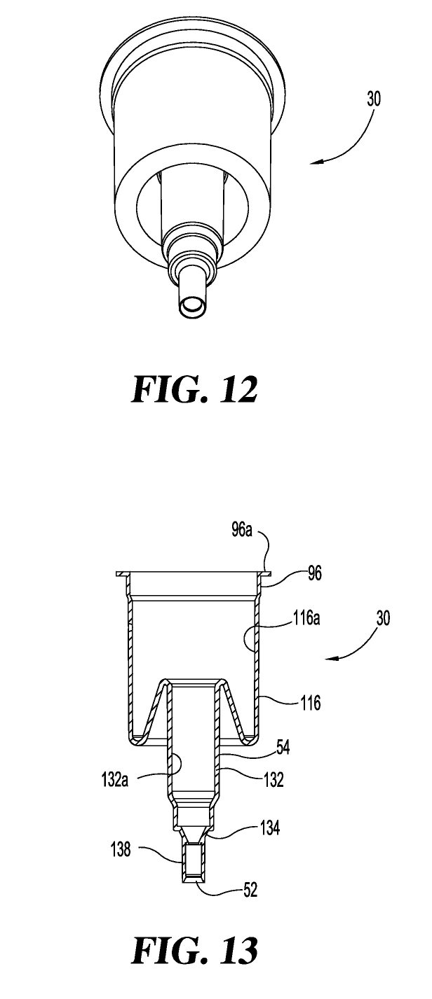

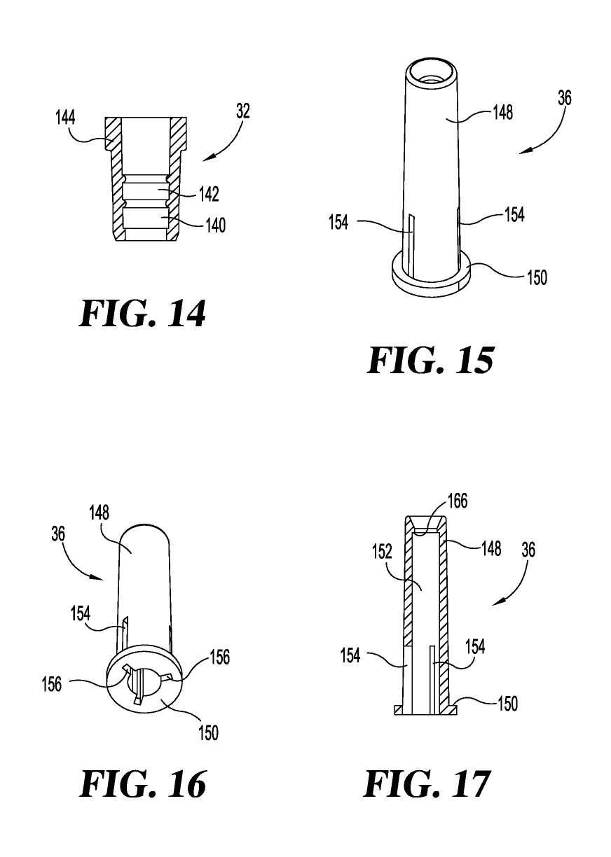

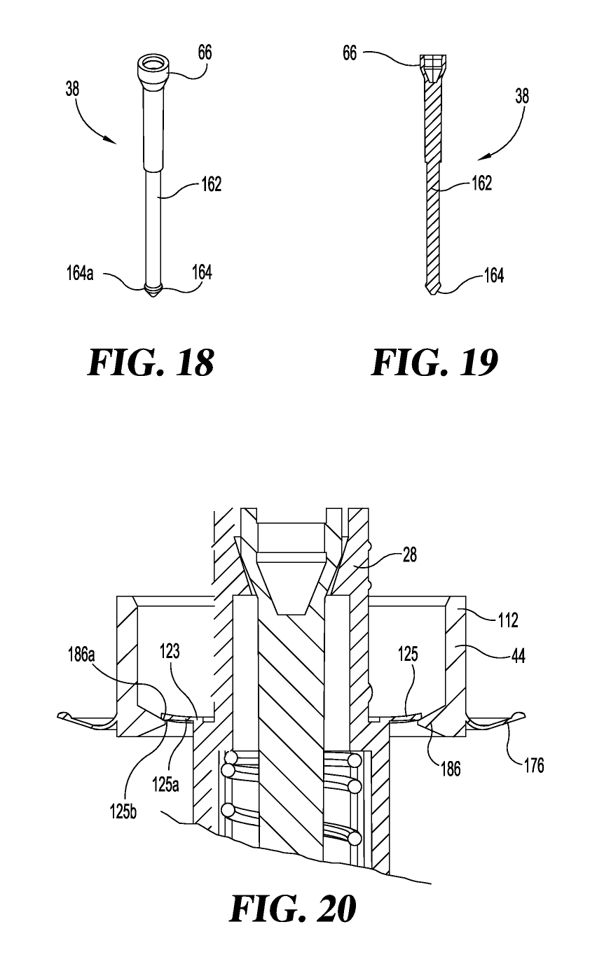

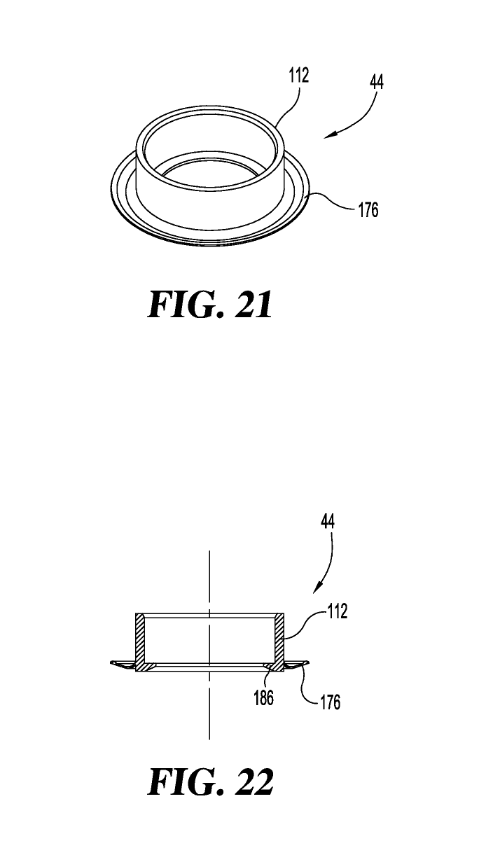

The structural details of actuator 22 are illustrated in FIGS. 4 and 5. The structural details of collar 24 are illustrated in FIGS. 6 and 7. The structural details of air piston 26 are illustrated in FIGS. 8 and 9. The structural details of liquid piston 28 are illustrated in FIGS. 10, 11A, 11B and 11C. The structural details of housing 30 are illustrated in FIGS. 12 and 13. The structural details of mesh insert 32 are illustrated in FIG. 14. The structural details of spring stem 36 are illustrated in FIGS. 15, 16 and 17. The structural details of pull stick 38 are illustrated in FIGS. 18 and 19. The structural details of valve element 44 are illustrated in FIGS. 21 and 22. The manner of assembly of the air valve structure 40 into pump 20 and the cooperation between valve element 44 and the liquid piston 28 is illustrated in FIG. 20.

With continued reference to FIGS. 1, 2 and 3, it is to be understood that the illustrated and disclosed foam-dispensing pump 20 is constructed and arranged to be threadedly assembled to the threaded neck of a suitable and corresponding dispensing container (not illustrated) which includes a supply of a selected liquid product. The selected liquid product depends on the intended or desired use for the foam, such as a cleaning product or a personal care product, as but a couple of examples. The connection between pump 20 and the dispensing container is by securely threading collar 24 onto the container neck until tight. Dip tube 50 provides the liquid connection or communication means between the liquid product in the dispensing container and pump 20. Dip tube 50 is constructed and arranged to slide into the interior opening of the end 52 of housing 30 with a slight interference fit. As such, dip tube 50 can be included and considered a part of pump 20 or alternatively, the dip tube 50 can be supplied as a separate component and not be considered a part of the pump 20. The length of dip tube 50 depends in part on the size of the container, a factor which favors supplying the dip tube 50 as a separate component.

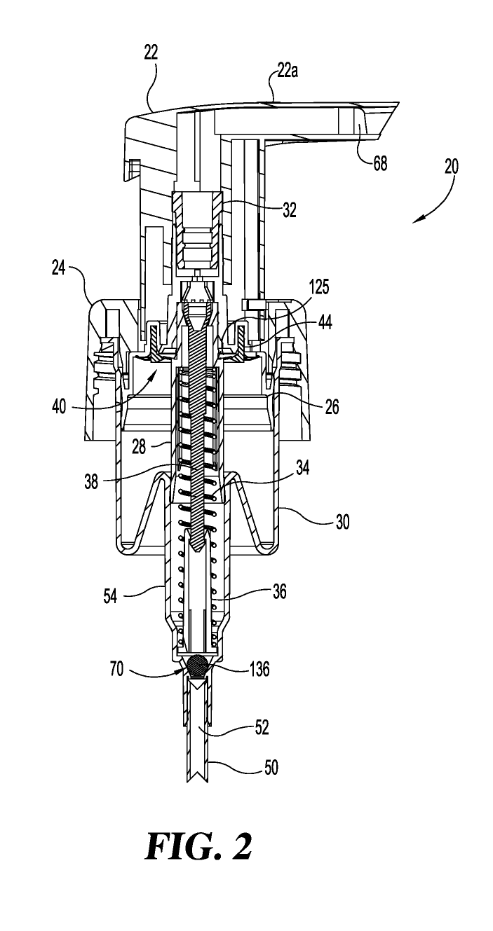

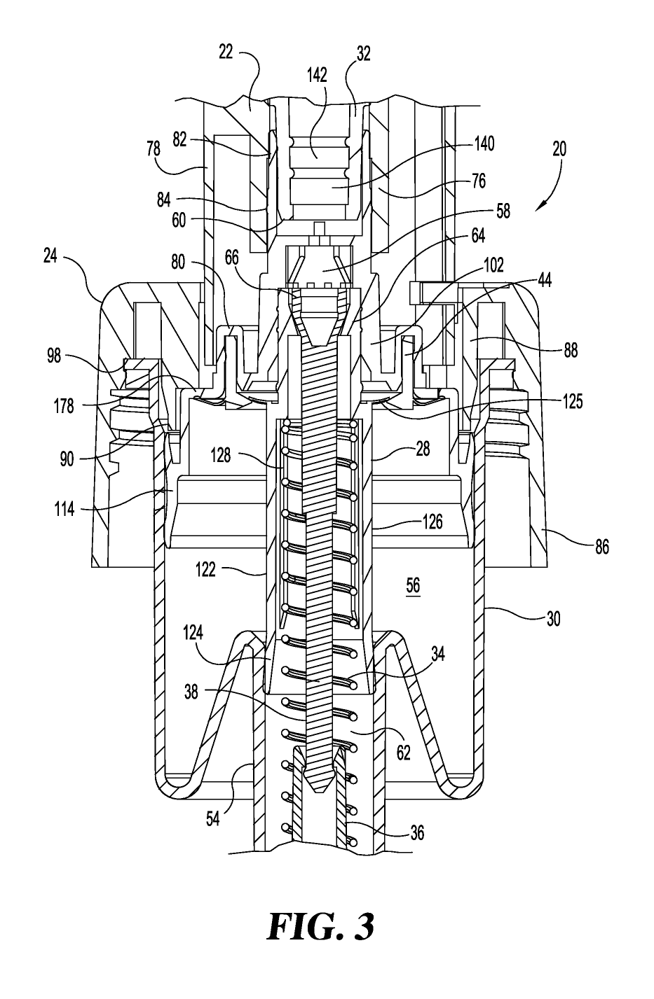

In use, the pump 20 is assembled to a suitable dispensing container which is holding a supply of a selected liquid product, and the initial step which needs to be performed by a user is to manually push in a downward direction on the upper surface 22a of actuator 22. Considering the mechanical configuration and arrangement of the cooperating component parts, see FIGS. 2 and 3, pushing downwardly on actuator 20 as the stroke for creating a dose of foam causes axially downward travel of air piston 26 within housing 30. This same actuator 22 motion (i.e. downward travel) also causes axially downward travel of liquid piston 28 within a lower portion 54 of housing 30.

As the air piston 26 travels within housing 30, the interior volume of their defined space 56 is reduced thereby resulting in an increase in the interior air pressure within space 56. This increased interior air pressure causes a radially inner portion of the air valve structure 40 to “open” in order to force a dose or charge of air into a mixing area such as mixing chamber 58 which is adjacent the entry end 60 of the mesh insert 32. A radially outer portion of the air valve structure 40 remains “closed”. Downward axial travel of the actuator 22 also effects downward axial travel of the liquid piston 28. The movement of the liquid piston 28 reduces the volume of space 62 which includes a charge of the liquid product. Concurrently with this downward movement, the upper end 64 of the liquid piston 28 separates from the enlarged head 66 of the pull stick 38. This separation creates a liquid flow path for liquid to flow into mixing chamber 58. The dose or charge of air and the dose or charge of liquid are combined within mixing chamber 58 before that air-liquid mixture is pushed into and through the mesh insert 32. The passage of the mixture through the mesh insert 32 results in the production of foam. The dose of foam which is produced is pushed out through the nozzle portion 68 of actuator 22.

The downward axial movement of the actuator 22 which in turn causes the downward axial movement of the air piston 26 and of the liquid piston 28 also causes the compression (i.e. shortening) of spring 34. When the manual force on the upper surface of the actuator 22 is relieved or released, the spring 34 is allowed to return to its extended starting condition. The spring force which is released as the spring returns to its starting condition causes the air piston 26 to move in an axially upward direction. This upward travel creates a negative pressure (i.e. a vacuum or suction) within defined space 56. This negative pressure causes the radially outward portion of the air valve structure 40 to “open” in order to admit make-up air into the defined space 56. While the air pressure within defined space 56 is being adjusted back to something close to atmospheric pressure, the radially inner portion of the air valve structure 40 begins to close. As soon as the positive pressure is lowered below the valve-open force level, the radially inner portion is closed.

The spring return force also drives the liquid piston 28 in an axially upward direction and the suction created opens the ball valve 70 and draws a new charge or dose of liquid up through the dip tube 50 from the liquid supply within the container. When the pressure within the defined space 56 is restored to substantially atmospheric pressure, the pump 20 is ready for another dispensing cycle (stroke) and the dispensing of another dose or charge of foam.

Referring now to FIGS. 4 and 5, the structural details of actuator 22 are illustrated. Actuator 22 is a unitary, single-piece, molded plastic component which includes nozzle portion 68, annular inner sleeve 76 and annular outer wall 78. The outer wall 78 is constructed and arranged to fit inside of collar 24 and to slide down around an annular wall portion 80 of air piston 26. In the preferred embodiment actuator 22 is “keyed” within a collar opening notch, by the use of wall projection 79. This keying structure prevents free rotation of the actuator 22 relative to the collar 24. Sleeve 76 is constructed and arranged to receive the annular upper extension 82 of air piston 26 with an interference fit due in part to the use of interference rib 84. The interior of upper extension 82 receives the lower portion of the mesh insert 32, also with a slight interference fit. The upper portion of the mesh insert 32 is received by sleeve 76, also with a slight interference fit.

Referring now to FIGS. 6 and 7, the structural details of collar 24 are illustrated. Collar 24 is a unitary, single-piece, molded plastic component which includes an annular, internally-threaded outer wall 86 and an annular inner wall 88. The outer wall 86 is constructed and arranged for its threads to mate with the external threads on the neck of a suitable and compatible dispensing container (not illustrated). The dispensing container retains a supply of a selected liquid product and individual doses or charges of that liquid product are drawn out by pump 20, mixed with air and aerated into a foam which is dispensed from nozzle portion 68.

The annular lower portion 90 of inner wall 88 fits within annular channel 92 of air piston 26. The space 94 between inner wall 88 and outer wall 86 received the upper portion 96 of housing 30, including radial flange 96a. Flange 96a seats up against annular ledge 98 of collar 24. Opening 100 receives the outer wall 78 of the actuator 22. The notch 101 receives wall projection 79.

Referring now to FIGS. 8 and 9, the structural details of air piston 26 are illustrated. Air piston 26 is a unitary, single-piece, molded plastic component which, in addition to those structural portions and features already identified, includes an annular, inner wall 102 which is generally concentric with extension 82 and which is positioned at the base of extension 82. The annular upper portion 64 of liquid piston 28 is received within inner wall 102. The upper surface 64a of portion 64 abuts up against annular ledge 106. Ledge 106 generally corresponds to where extension 82 transitions into inner wall 102. Axial ribs 108 (6 total) are molded integrally as part of the annular inner surface 102a of inner wall 102. Each rib 108 is formed with two (2) small, spaced-apart recesses 108a for a snap-fit assembly of the liquid piston 28 (specifically upper portion 64). The outer surface of upper portion 64 includes two (2), raised, spaced-apart ribs 64b which are constructed and arranged for a snap-fit into corresponding ones of recesses 108a. The use of ribs 108 creates six (6) air-flow passages 110 which are defined by surface 102a, portion 64 and ribs 108. These air-flow passages 110 provide a flow path for mixing air to flow from the defined space 56 into the mixing chamber 58.

The liquid piston 28 is integrally formed (i.e. molded) with an outwardly radiating, flexible valve lip 125 which controls the flow of mixing air into the air-flow passages 110. Valve lip 125 is adjacent a corresponding entry location for each air-flow passage 110. The lower portion of each rib 108 is inclined radially outwardly thereby creating a complete circumferential clearance ring which is frustoconical in shape. This clearance ring allows the air flow past the outer edge of lip 125 to flow into flow passages 110. This clearance ring corresponds to the referenced entry location. The positive pressure required to open or raise 125 is comparatively low as compared to other air valve structures and this facilitates the adequacy of the flow of mixing air and the responsiveness of the air valve structure 40.

Annular wall portion 80 includes an annular inner wall 80a and an annular outer wall 80b. Walls 80a and 80b are substantially concentric and cooperatively define therebetween annular groove 80c. Groove 80c receives an annular upper wall 112 of valve element 44 (see FIGS. 20, 24 and 25).

Air piston wall 114 is constructed and arranged for a tight sliding fit within housing 30. Wall 114 fits tightly up against the inner surface 116a of housing wall 116. The tight fit is for sealing, while still being at a force level which permits the sealing lips 114a of wall 114 to slide over the inner surface 116a. This sliding movement causes the volume of the defined space 56 to change in a controlled manner for both the delivery of mixing air and for drawing in make-up air.

Referring now to FIGS. 10, 11A, 11B and 11C, the structural details of liquid piston 28 are illustrated. The design modifications to liquid piston 28 based on alternative valve lip constructions are identified as liquid pistons 28a (see FIG. 11B) and 28b (see FIG. 11C). Liquid piston 28 is a unitary, single-piece, molded plastic component which, in addition to those structural portions and features already identified, includes annular wall 122 which flares outwardly into annular sealing edge 124. The transition and change in size from upper end 64 to wall 122 creates an off-set annular ledge 123. Integrally formed as part of ledge 123 is an annular, outwardly radiating valve lip 125. Liquid pistons 28a and 28b have the same construction as liquid piston 28, except for the design of the valve lip 125. Valve lip 125 extends radially outwardly from ledge 123 and is used as part of air valve structure 40 for the delivery of mixing air for foam production. The inner surface 126a of lower portion 126 of wall 122 includes six (6) axial ribs 128. Collectively and cooperatively, the inner surface of each rib 128 defines a generally cylindrical space which receives spring 34. Pull stick 38 extends through the center of spring 34 and its enlarged head 66 is received within upper portion 64 of liquid piston 28. Sealing edge 124 is constructed and arranged with a tight sliding fit against the inner surface 132a of wall 132 of housing 30. Edge 124 fits tightly up against the inner surface 132a and edge 124 slides on inner surface 132a with axial movement of actuator 20 and with return movement due to spring 34. This sliding movement causes the volume of lower portion 54 to change in a controlled manner for the delivery of mixing liquid and for drawing in another dose or charge of liquid.

Referring now to FIG. 11B, liquid piston 28a is constructed and arranged the same as liquid piston 28, with the exception of the construction and arrangement of the annular valve lip 125a. The function of liquid piston 28a relative to the remainder of pump 20 is also the same as what occurs with liquid piston 28, except for a higher preload force of the annular valve lip on surface 186a of annular shelf 186.

Annular valve lip 125a includes an annular body portion 127a, and outer annular tip 127b and a bend 127c which is located between a first section 127d of the body portion 127a and a second section 127e of the body portion 127a. Tip 127b is slightly enlarged and rounded on its lower surface for improved sealing contact against surface 186a. The bend 127c is concave from the underside and convex from the upper surface. The actual bend in this embodiment is an included angle of approximately 135 degrees. The first section 127d and the second section 127e are each substantially “straight” in the cross-section view resulting in more of a point or edge on the convex side, as compared to the rounded bend 129c of annular valve lip 125b (see FIG. 11C).

The shaping and contouring of annular valve lip 125a results in this valve lip having a higher preload force as compared to valve lip 125. The shaping and contouring is partially responsible for this higher preload force. Also partially responsible for this higher preload force is the shorter moment arm relative to a potential deflection or pivot point at the bend. Another option for increasing the preload force is to initially mold the valve lip such that the lower surface of tip 127b is axially lower. In order to position tip 127b on surface 186a, there is more deflection of the valve lip required when the tip 127b is axially lower and thus a higher preload force.

Referring now to FIG. 11C, liquid piston 28b is constructed and arranged the same as liquid piston 28, with the exception of the construction and arrangement of the annular valve lip 125b. The function of liquid piston 28b relative to the remainder of pump 20 is also the same as what occurs with liquid piston 28, except for a higher preload force of the annular valve lip on surface 186a of annular shelf 186. Annular valve lip 125b includes an annular body portion 129a, an outer annular tip 129b and a bend 129c which is located between a first section 129d of the body portion 129a and a second section 129e of the body portion 129a. Tip 129b is slightly enlarged and rounded on its lower surface for improved sealing contact against surface 186a. The bend 129c is concave from the underside and convex from the upper surface. The actual bend in this embodiment is a rounded contour which smoothly extends between and provides the transition for the first section 129d and the second section 129e. The generally “straight” portion of each section 129d and 129e (based on the cross-sectional view) is a little shorter in this embodiment as compared to valve lip 125a due to the start of the curvature section which provides bend 129c.

The shaping and contouring of annular valve lip 125b results in this valve lip having a higher preload force as compared to valve lip 125. The shaping and contouring of valve lip 125b is responsible for this higher preload force due to the curvature of the bend. When air pressure is present and works to deflect the annular valve lip, the air pressure loading force on the valve lip is used up, at least in part, to initially try and straighten the curvature rather than simply deflecting the valve lip at its pivot location which is the point of attachment to the remainder of the liquid piston. Another option for increasing the preload force is to initially mold the valve lip such that the lower surface of tip 129b is axially lower. In order to position tip 129b on surface 186a, there is more deflection of the valve lip required when it is initially axially lower and thus a higher preload force when placed on surface 186a.

Referring now to FIGS. 12 and 13 the structural details of housing 30 are illustrated. Housing 30 is a unitary, single-piece, molded plastic component which, in addition to those structural portions and features already identified, includes conical wall portion 134 which receives the ball 136 of the liquid check valve 70 which is created in part by wall portion 134. Housing 30 also includes generally cylindrical sleeve 138 which defines open end 52 and which is sized and arranged to receive dip tube 50 with a light interference fit.

Referring now to FIG. 14, the structural details of mesh insert 32 are illustrated. Mesh insert 32 is a annular structure with an interior size and shape which is suitable to capture a coarse mesh screen 140 and downstream therefrom, a fine mesh screen 142. Each mesh screen 140 and 142 is a unitary, single-piece, molded plastic component which has a suitable snap-in structure for secure placement and fit within body 144. Body 144 is a unitary, single-piece molded plastic component.

Referring now to FIGS. 15, 16 and 17, the structural details of spring stem 36 are illustrated. Spring stem 36 is a unitary, single-piece, molded plastic component which includes a generally cylindrical body 148 and an annular base flange 150. Body 148 defines a hollow interior 152 extending through the entire length of stem 36, including flange 150. Body 148 also defines three (3) slots 154 and each slot 154 extends from its closed end axially through base flange 150. Each slot creates a corresponding breakout opening 156 in the lower surface of base flange 150. Slots 154 provide passageways for the flow of liquid.

Referring now to FIGS. 18 and 19, the structural details of pull stick 38 are illustrated. Pull stick 38 is a unitary, single-piece, molded plastic component which, in addition to enlarged head 66, includes an elongate body 162 which extends between head 66 and base 164. Base 164 is received within spring stem 36, see FIGS. 2 and 3. Radial lip 164a abuts against inner annular edge 166 of spring stem 36. Elongate body 162 extends through a portion of the interior of spring 34.

Referring now to FIG. 20, air valve structure 40 is illustrated. Air valve structure 40 is a combination of annular valve lip 125 and annular valve element 44 (see FIGS. 21 and 22). Valve lip 125 is integrally formed as part of liquid piston 28. Valve element 44 includes upper wall 112 which is received within annular space 80c. Annular lip 176 which extends radially outwardly from wall 112 is flexed into a sealing preload against the inner surface 178a of upper wall 178. Wall 178 defines four (4) air apertures 180 and these air apertures are initially closed off by the presence of lip 176 as preloaded up against surface 178a. When a sufficient negative pressure (i.e. suction) is experienced within defined space 56, lip 176 is pulled away from its covering orientation over each aperture 180 thereby allowing make-up air to be drawn into defined space 56, via the four (4) apertures 180.

In the air valve structure 40, the valve lip 125 is flexed into a deflected, sealing preload against the upper annular surface 186a of annular shelf 186 of valve element 44. When a positive pressure is present within defined space 56, due to the axial movement of actuator 22 and thereby the movement of air piston 26, lip 125 is pushed upwardly (i.e. raised) off of surface 186a. The resulting separation between lip 125 and surface 186a creates an air-flow passage for air within defined space 56 to be delivered to the mixing chamber 58 for mixing with the charge of liquid for foam production. When the positive pressure is removed (due to the entry of make-up air) lip 125 closes back against surface 186a. Valve lip 125 includes an annular body portion 125c which extends to and is surrounded by enlarged annular tip 125d. Portion 125c has a thickness of approximately 0.20 mm and tip 125d has a thickness of approximately 0.30 mm. The functional aspects described for lip 125 apply equally to valve lip 125a and to valve lip 125b. The difference as noted above is using the shaped geometry or contours of valve lips 125a and 125b in order to establish a higher preload force on shelf 186.

The air valve structure 40 provides a simple and reliable air valve for the delivery of mixing air and the receipt of make-up air. The structural shapes and cooperative interfit of lip 125 onto edge 186a provide added simplicity to the other component parts of pump 20.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A foam-dispensing pump comprising:
an actuator;
a collar constructed and arranged for attachment to a liquid storage container, wherein a portion of said actuator is received by said collar;
a housing;
an air piston which is constructed and arranged to be moveable within said housing;
a liquid piston which is constructed and arranged to be moveable within said housing;
a mesh element which is constructed and arranged to receive air and liquid for the production of foam; and
an air valve structure including an annular valve lip which is formed as part of said liquid piston and a cooperating annular valve element received by said air piston.

2. The foam-dispensing pump of claim 1 wherein an upper portion of said liquid piston is received within an annular portion of said air piston.

3. The foam-dispensing pump of claim 2 wherein the assembly of said liquid piston into said air piston is by a snap-fit into recesses defined by interior ribs of said piston.

4. The foam-dispensing pump of claim 1 wherein an interfit between said liquid piston and said air piston defines a plurality of air-flow passages for mixing air.

5. The foam-dispensing pump of claim 4 wherein said annular valve lip is adjacent a corresponding entry location for each air-flow passage.

6. The foam-dispensing pump of claim 1 wherein said liquid piston includes an offset annular ledge and said annular valve lip extends radially outwardly from said ledge.

7. The foam-dispensing pump of claim 1 wherein said air valve structure is constructed and arranged with said annular valve lip in a deflected, preloaded orientation against a portion of said annular valve element.

8. The foam-dispensing pump of claim 7 wherein said portion is a radially inner, annular edge of said annular valve element.

9. The foam-dispensing pump of claim 1 wherein the annular valve element includes an annular upper wall which is received within an annular groove defined by generally concentric walls of the air piston.

10. The foam-dispensing pump of claim 9 wherein said annular valve element further includes an outwardly extending annular lip for use in managing make-up air.

11. The foam-dispensing pump of claim 10 wherein said annular valve element further includes an inwardly extending projection for use in cooperation with said annular valve lip for managing mixing air.

12. The foam-dispensing pump of claim 1 wherein said annular valve lip includes a body portion and is constructed and arranged with a bend in said body portion.

13. The foam-dispensing pump of claim 12 wherein said bend is located between two substantially straight sections of said body portion.

14. The foam-dispensing pump of claim 12 wherein said bend is a curved section of said body portion.

15. A foam-dispensing pump comprising:
an actuator;
a collar constructed and arranged for attachment to a liquid storage container, wherein a portion of said actuator is received by said collar;
a housing;
an air piston which is constructed and arranged to be moveable within said housing;
a liquid piston which is constructed and arranged to be moveable within said housing;
means for the production of foam; and
an air valve structure constructed and arranged with a first component including an annular valve lip and a cooperating second component assembled into the air piston.

16. The foam-dispensing pump of claim 15 wherein said first component is said liquid piston.

17. The foam-dispensing pump of claim 15 wherein a snap-fit assembly exists between the liquid piston and the air piston and a plurality of air-flow passages are defined by this snap-fit assembly.

18. The foam-dispensing pump of claim 15 wherein said annular valve lip includes a body portion of a first thickness and an enlarged tip with a thickness which is greater than said first thickness.

19. The foam-dispensing pump of claim 18 wherein said enlarged tip establishes sealing contact against a portion of said annular valve element.

20. The foam-dispensing pump of claim 15 wherein said annular valve lip includes a body portion and is constructed and arranged with a bend in said body portion.

21. The foam-dispensing pump of claim 20 wherein said bend is located between two substantially straight sections of said body portion.

22. The foam-dispensing pump of claim 20 wherein said bend is a curved section of said body portion.

23. An air valve structure for use in a foam-dispensing pump which includes an air piston and a liquid piston, said air valve structure comprising:
an annular valve lip which is integrally formed as a portion of the liquid piston; and
an annular valve element which is constructed and arranged to assemble into a portion of said air piston.

24. The air valve structure of claim 23 wherein said air valve structure is constructed and arranged with said annular valve lip in a deflected, preloaded orientation against a portion of said annular valve element.

25. The foam-dispensing pump of claim 24 wherein said annular valve lip includes a body portion of a first thickness and an enlarged tip with a thickness which is greater than said first thickness.

26. The foam-dispensing pump of claim 25 wherein said enlarged tip establishes sealing contact against a portion of said annular valve element.

27. The foam-dispensing pump of claim 23 wherein said annular valve lip includes a body portion and is constructed and arranged with a bend in said body portion.

28. The foam-dispensing pump of claim 27 wherein said bend is located between two substantially straight sections of said body portion.

29. The foam-dispensing pump of claim 27 wherein said bend is a curved section of said body portion.
